(19) United States
(12) Patent Application Publication
(10) Pub. No.: US 2021/0162763 A1
(43) Pub. Date: Jun. 3, 2021

(54) FLUID EJECTION INTER-MODULE GAP

(71) Applicant: Hewlett-Packard Development Company, L.P., Spring, TX (US)

(72) Inventors: Seth Haddix, Corvallis, OR (US); Andrew Duggan, Corvallis, OR (US); Zachary R. Chan, Corvallis, OR (US); Alan R. Arthur, Corvallis, OR (US)

(73) Assignee: Hewlett-Packard Development Company, L.P., Spring, TX (US)

(21) Appl. No.: 17/047,709

(22) PCT Filed: Jun. 14, 2018
(86) PCT No.: PCT/US2018/037656

§ 371 Date: Oct. 15, 2020

(51) Int. Cl. B41J 2/165

(52) U.S. Cl. CPC B41J 2/16585; B41J 2202/19; B41J 2002/1655; B41J 2/16535

(57) ABSTRACT

A fluid ejection system may include a first fluid ejection module and a second fluid ejection module. The first fluid ejection module may include a first end, a first module face and a first row of first ejection heads having first ejection faces along the first module face. The second fluid ejection module may include a second end opposite the first end, a second module face and second ejection heads having second ejection faces along the second module face. The first module face and the second module face are spaced by an inter-module mesoscale gap.

### BACKGROUND

Fluid ejection systems, such as three-dimensional printers or flat media printers, sometimes utilize fluid ejection modules supported in an end-to-end relationship so as to collectively span a wider region onto which a fluid is to be dispensed. Such modules may include rows of individual fluid ejection devices or heads, sometimes referred to as ejection heads. The fluid ejection heads are sometimes serviced with a wiper that moves between the modules across the heads.

### BRIEF DESCRIPTION OF THE DRAWINGS

FIG. 1 is a side view schematically illustrating portions of an example fluid ejection system.

FIG. 2 is a side view schematically illustrating portions of an example fluid ejection system.

FIG. 3 is a side view schematically illustrating portions of an example fluid ejection system.

FIG. 4 is a side view schematically illustrating portions of an example fluid ejection system.

FIG. 5 is a side view of portions of an example fluid ejection system.

FIG. 6 is a flow diagram of an example fluid ejection head wiping method.

FIG. 7 is a bottom view of portions of an example fluid ejection system.

FIG. 8 is a bottom perspective view of portions of an example fluid ejection system.

FIG. 9 is a bottom perspective view of portions of an example fluid ejection system.

FIG. 10 is a bottom perspective view of portions of an example fluid ejection system.

FIG. 11 is a sectional view of portions of the example fluid ejection system of FIG. 10, illustrating portions of an example wiping subsystem.

FIG. 12 is a bottom perspective view of portions of the example fluid ejection system of FIG. 11.

FIG. 13 is an enlarged sectional view of portions of the example fluid ejection system of FIG. 12.

FIG. 14 is an enlarged sectional view of portions of an example fluid ejection system.

FIG. 15 is a bottom perspective view of portions of an example fluid ejection system.

FIG. 16 is a bottom perspective view of portions of the example fluid ejection system of FIG. 15.

FIG. 17 is a bottom perspective view of portions of an example fluid ejection system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example fluid ejection systems, methods and shrouds that enhance servicing and wiping of ejection heads. The disclosed ejection systems, methods and shrouds reduce or eliminate the bump or bounce that otherwise occurs as a wiper moves from one fluid ejection module to another fluid ejection module. The disclosed ejection systems, methods and shrouds reduce or eliminate such bounce by reducing the gap between consecutive end-to-end ejection modules, the inter-module gap.

In one implementation, the inter-module gap is a mesoscale gap, a gap of at least 0.1 mm and no greater than 5 mm. In one implementation, a module Is less than or equal to 1.3 mm. In one implementation, the wiper is rounded with a diameter, wherein the inter-module gap is less than or equal to 7% of the diameter. In one implementation, the wiper comprises a roller having the diameter, wherein the inter-module gap is less than or equal to 7% of the diameter. In another implementation, the inter-module gap is sized such that the wiper, when moving from the first module to the second module, contacts a bridging surface of a bumper disposed between bodies of the first module and the second module before contacting the body of the second module. In one implementation, the fluid ejection module comprises a bumper mounted to or integrally formed as part of the fluid ejection module. In one implementation, the bumper is provided as part of or mounted to a shroud having a rim outwardly extending from an end wall, wherein the bumper, providing a bridging surface, also outwardly extends from the end wall.

Disclosed is an example fluid ejection system that may include a first fluid ejection module and a second fluid ejection module. The first fluid ejection module may include a first end, a first module face and a first row of first ejection heads having first ejection faces along the first module face. The second fluid ejection module may include a second end opposite the first end, a second module face and second ejection heads having second ejection faces along the second module face. The first module face and the second module face are spaced apart by a mesoscale inter-module gap.

Disclosed is an example method for wiping fluid ejection heads of consecutive fluid ejection modules. The method may include moving a wiper along a first ejection face of a first fluid ejection head on a first module, moving the wiper from the first module across a lower face of the first module adjacent the first ejection face towards a second module, moving the wiper across at least one bridging surface of at least one bumper and across an inter-module gap onto the second module, wherein the wiper contacts the at least one bridging surface prior to contacting the second module, moving the wiping roller across a lower face of the second module, and moving the wiping roller along a second ejection face of a second fluid ejection head on the second module.

Disclosed is an example shroud for fluid ejection heads of a fluid ejection module. The shroud may include a panel extending in a plane and having openings through which the fluid ejection heads project, an end wall projecting from the panel, a rim extending outwardly from the end wall away from the panel, and a bumper extending outwardly from the end wall away from the panel, the bumper having a bridging surface spaced from the rim proximate the plane of the panel to reduce an inter-module gap.

FIG. 1 schematically illustrates portions of an example fluid ejection system 20. Fluid ejection system 20 reduces or eliminates the bump or bounce that otherwise occurs as a wiper moves from one fluid ejection module to another fluid ejection module. The disclosed ejection systems, methods and shrouds reduce or eliminate such bounce by reducing the gap between consecutive end-to-end ejection modules, the inter-module gap. Fluid ejection system 20 comprises fluid ejection modules 24A, 24B (collectively referred to as modules 24).

Fluid ejection modules 24 each comprise a module face 26 and a row 27 of fluid ejection heads 28. Module faces 26 comprise the lower surfaces or faces of modules 24 that face the underlying region onto which fluid is ejected. In one implementation, module faces 26 are coplanar and extend between fluid ejection heads 28. As will be described hereafter, during wiping of fluid ejection heads 28, a wiper is moved across and bears against module faces 26 as the wiper moves from one head 28 to another and moves between modules 24.

Ejection heads 28 each have an ejection face 30 through which fluid is controllably ejected. In one implementation, each of ejection heads 28 comprises an individual die or a group of dies (sometimes referred to as slivers) joined together to form the individual ejection head. Each ejection head 28 may comprise a row or multiple rows of fluid ejection nozzles or orifices adjacent chambers, wherein fluid supplied to such chambers is forcefully displaced through the orifices to jet droplets of fluid from the ejection faces. Each of modules 24 supports and joins its respective group or array of heads 28 as a single unit which may be mounted or supported as part of fluid ejection system 20.

As further shown by FIG. 1, modules 24 have opposing ends 34A, 34B (collectively referred to as ends 34). Ends 34 face in directions parallel to the axes along which rows 27 extend. Ends 34 face one another and separate module faces 26 of modules 24 by an inter-module gap G. The inter-module gap G is the space between the closest points or surfaces of module faces 26 in a direction parallel to the direction of rows 27. The inter- module gap is the space that a wiper must traverse as it is moved from an edge of one of modules 24 on to and across the opposite edge of another one of modules 24.

In systems where the fluid ejection heads 30 are wiped using a wiper having a convex wiping profile, whether rounded, or polygonal, the apex of the wiping profile may temporarily dip or project into the inter-module gap G as it leaves one module and prior to reaching the consecutive module. Continued movement of the wiper towards the consecutive module may result in the apex of the wiper jumping or bouncing out of the inter-module gap G and onto the consecutive module. This jumping or bouncing may cause air to be ingested through the nozzle orifices of the initially engaged fluid ejection head 28, potentially reducing performance of system 20.

To reduce or eliminate such bouncing, modules 24 are supported, shaped and dimensioned such that the inter-module gap G is within a mesoscale range. For purposes of this disclosure, for a gap to be within the mesoscale range or to be a “mesoscale gap”, the gap is at least 0.1 mm and no greater than 5 mm. In one implementation, the gap is no greater than 1.3 mm. Because inter-module gap G is a mesoscale gap, the convex profile of the wiper dips or project into the inter-module gap G to a lesser extent or not at all as it crosses the inter-module gap G. As a result, such bouncing and potential air ingestion is reduced or eliminated.

FIG. 2 schematically illustrates portions of an example fluid ejection system 120. Fluid ejection system 120 is similar to fluid ejection system 20 described above except that fluid ejection system 120 is additionally illustrated as comprising convex wiper 150. Convex wiper 150 has a convex profile 152 which faces surfaces 26 as wiper 150 is moved across faces 26 in the direction indicated by arrow 154. Convex profile 152 has an apex 156. In the example illustrated, convex profile 152 is curved or rounded. In other implementations, convex profile 152 may be polygonal, having multiple facets that form the overall convex profile 152.

During wiping of an individual fluid ejection face 30 of an individual fluid ejection head 28, convex wiper 150 presses a wiping surface against the fluid ejection face 30 so as to remove fluid remnants and clean fluid ejection faces 30. In one implementation, the wiping surface may comprise a rubber or elastomeric material along at least portions of profile 152 so as to contact fluid ejection faces 30.

In another implementation, the wiping surface may comprise a fluid absorbent surface along at least portions of profile 152. In one implementation, the fluid absorbent surface may comprise a fluid absorbent fabric or other absorbent material fixed or retained relative to wiper 150 along at least portions of profile 152 so as to contact and wipe across the fluid ejection faces 30 of fluid ejection heads 28 as wiper 150 is moved in the direction indicated by arrow 154. In yet another implementation, convex wiper 150 may comprise a web of fluid absorbent material that is moved between profile 152 and the opposing module 24A, 24B, either during wiping of a fluid ejection head 28 or between the wiping of different fluid ejection heads 28. In one implementation, the web may be held against profile 152 so as to have a corresponding profile. In another implementation, the web may tangentially extend across the apex 156, wherein the apex 156 of wiper 150 presses the web of wiping material against the fluid ejection face 30 of a fluid ejection head 28 during wiping.

In the example illustrated, the inter-module gap G between faces 26 of modules 24 is based upon a size and dimensioning of profile 152 and of apex 156. In one implementation, profile 152 is rounded, the curved or rounded surface having a diameter (radius of curvature). In such an implementation, the inter-module gap G provided between modules 24 is based upon the diameter/radius of curvature so as to reduce or eliminate an extent to which the apex 156 projects into the gap G as it traverses the gap G. In such an implementation, the inter-module gap G is no greater than 7% of the diameter of profile 152. In some implementations, the inter-module gap G may be greater than 1.3 mm but no greater than 7% of the diameter of profile 152.

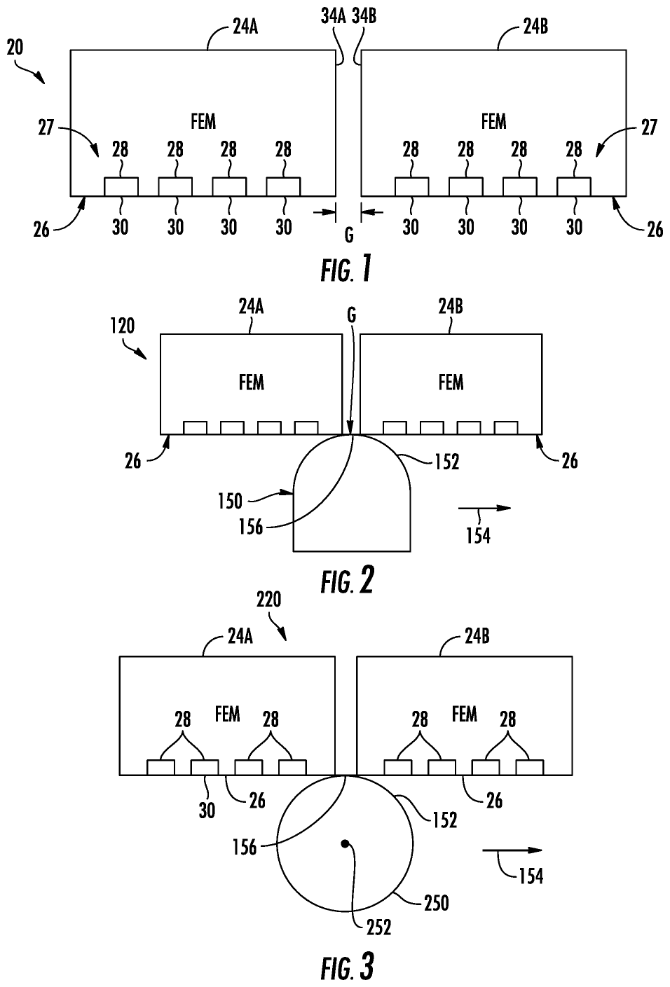

FIG. 3 schematically illustrates portions of an example fluid ejection system 220. Fluid ejection system 220 is similar to fluid ejection system 120 except that fluid ejection system 220 comprises a wiper in the form of a wipe roller 250. Those remaining components of fluid ejection system 220 which correspond to components of fluid ejection system 120 are numbered similarly.

As with convex wiper 150, wipe roller 250 has a convex profile 152 which faces surfaces 26 as wiper 250 is moved/rolled across faces 26 in the direction indicated by arrow 154. Convex profile 152 has an apex 156 closest to the plane or planes containing surfaces 26. In the example illustrated, convex profile 152 is curved or rounded. In other implementations, convex profile 152 may be polygonal, having multiple facets that form the overall convex profile 152.

During wiping of an individual fluid ejection face 30 of an individual fluid ejection head 28, convex wiper 250 presses a wiping surface against the fluid ejection face 30 so as to remove fluid remnants and clean fluid ejection faces 30. In one implementation, the wiping surface may comprise a rubber or elastomeric material along at least portions of profile 152 so as to contact fluid ejection faces 30.

In another implementation, the wiping surface may comprise a fluid absorbent surface along at least portions of profile 152. In one implementation, the fluid absorbent surface may comprise a fluid absorbent fabric or other absorbent material fixed or retained relative to wipe roller 250 along at least portions of profile 152 so as to contact and wipe across the fluid ejection faces 30 of fluid ejection heads 28 as wipe roller 250 is moved in the direction indicated by arrow 154. In yet another implementation, wipe roller 250 may comprise a web of fluid absorbent material that is moved between profile 152 and the opposing module 24A, 24B, either during wiping of a fluid ejection head 28 or between the wiping of different fluid ejection heads 28. In one implementation, the web may be held against profile 152 so as to have a corresponding profile. In another implementation, the web may tangentially extend across the apex 156, wherein the apex 156 of wipe roller 250 presses the web of wiping material against the fluid ejection face 30 of a fluid ejection head 28 during wiping. In one implementation, liberal or 250 is itself rotated about axis 252 as it is being moved across and wiping fluid ejection faces 30 of fluid ejection heads 28 as indicated by arrow 154.

In the example illustrated, the inter-module gap G between faces 26 of modules 24 is based upon a size and dimensioning of profile 152 and of apex 156. In one implementation, profile 152 is rounded, the curved or rounded surface having a diameter (radius of curvature). In such an implementation, the inter-module gap G provided between modules 24 is based upon the diameter/radius of curvature so as to reduce or eliminate an extent to which the apex 156 projects into the gap G as it traverses the gap G. In such an implementation, the inter-module gap G is no greater than 7% of the diameter of profile 152. In some implementations, the inter-module gap G may be greater than 1.3 mm but no greater than 7% of the diameter of profile 152.

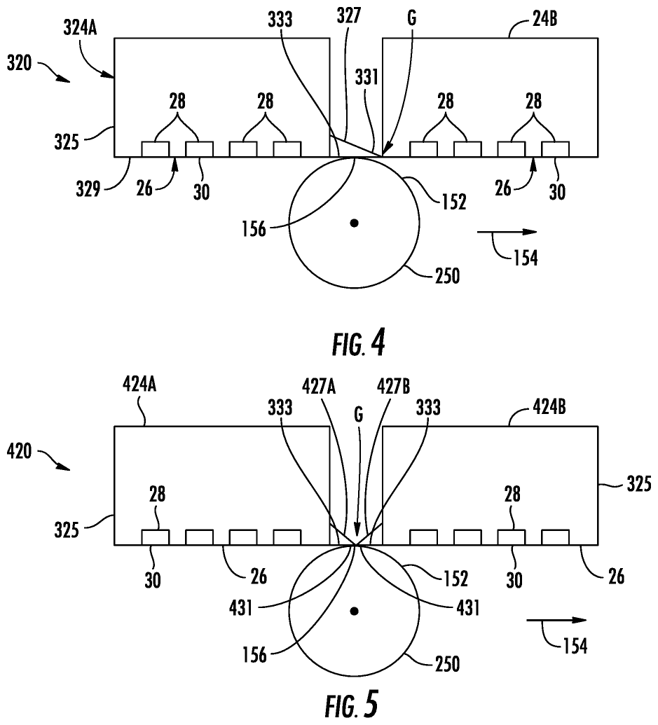

FIG. 4 schematically illustrates portions of an example fluid ejection system 320. Fluid ejection system 320 is similar to fluid ejection system 220 described above except that fluid ejection system 320 is illustrated as comprising fluid ejection module 324A in place of module 24A. Those remaining components of fluid ejection system 320 which correspond to components of fluid ejection system 220 are numbered similarly.

Fluid ejection module 324A is itself similar to fluid ejection module 24A except that fluid ejection module 324A is specifically illustrated as comprising main body 325 and bumper 327. Main body 325 comprises at least one structure that extends between and connects the fluid ejection heads 28 as a single unit. Main body 325 has a lower face 329 that cooperates with bumper 327 to form the module face 26. In one implementation, the lower face 329 is provided by a shroud that forms part of main body 325, the shroud having openings through which fluid ejection heads 28 project or through which fluid from fluid ejection heads 28 is jetted. In one implementation, lower face 329 extends in a plane is coplanar with module face 26 of module 24B.

Bumper 327 outwardly projects from an end of main body 325 towards module 24B, wherein the outer tip 331 of bumper 327 forms the end of module 324A and is spaced from the end of face 26 of module 24B to define the inter-module gap G. In one implementation, the inter-module gap G extending between the tip 331 of bumper 327 and module face 26 of module 24B a mesoscale gap. In one implementation, the a module gap G is no greater than 1.3 mm. In another implementation, the inter-module gap G is no greater than 7% of a diameter or radius of curvature of the profile 152, whether it be that of wipe roller 250 or convex wiper 150.

Bumper 327 has a bridging surface 333 facing the same direction of fluid ejection faces 30. In the example illustrated, bridging surface 333 extends in a plane parallel to a plane containing module faces 26 of module 324A and 24B. In one implementation, bridging surface 333 is coplanar with module faces 26, wherein the bridging surface 333 is flush with module faces 26. In another implementation, bridging surface 333 may be slightly recessed with respect to module faces 26, wherein wipe roller 250, when moving from module 324A to module 24B contacts bridging surface 333 prior to contacting module 24B. In one implementation, bridging surface 333 is recessed from module faces 26 by no greater than 0.25 mm.

FIG. 5 schematically illustrates portions of an example fluid ejection system 420. Fluid ejection system 420 is similar to fluid ejection system 320 except that fluid ejection system 420 comprises fluid ejection modules 424A and 424B (collectively referred to as modules 424). Each of modules 424 is similar to module 324A described above except that modules 424A and 424B comprise bumpers 427A and 4276, respectively (collectively referred to as bumpers 427), that project from main body 325 towards one another and have tips 431 that are spaced from one another in which cooperate with one another so as to form inter-module gap G.

In one implementation, the inter-module gap G extending between the tip 431 of bumper 427A and tip 431 of bumper 427B is a mesoscale gap. In one implementation, the inter-module gap G is no greater than 1.3 mm. In another implementation, the inter-module gap G is no greater than 7% of a diameter or radius of curvature of the profile 152, whether it be that of wipe roller 250 or convex wiper 150.

Each of bumpers 427 has a bridging surface 333 facing same direction of fluid ejection faces 30. In the example illustrated, bridging surface 333 extends in a plane parallel to a plane containing module faces 26 of modules 424. In one implementation bridging surface 333 is coplanar with module faces 26, wherein the bridging surface 333 is flush with module faces 26. In another implementation, bridging surface 333 may be slightly recessed with respect to module faces 26, wherein wipe roller 250, when moving from module 424A to module 424B contacts bridging surface 333 prior to contacting module 424B. In one implementation, bridging surfaces 333 are recessed from module faces 26 by no greater than 0.25 mm.

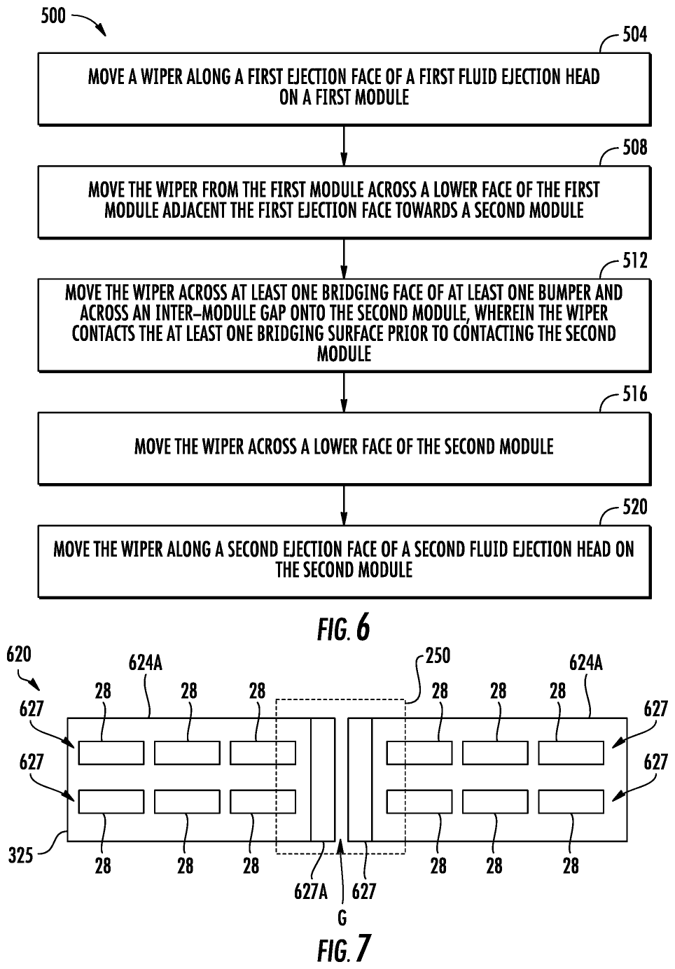

FIG. 6 is a flow diagram of an example fluid ejection module wiping method 500. Method 500 facilitates wiping of fluid ejection heads of two end-to-end fluid ejection modules with reduced bouncing of a wiper during movement of the wiper from one module to another module to reduce air ingestion. Method 500 facilitates such reduced bouncing by reducing the size of an inter-module gap between such modules. In the example illustrated, method 500 reduces the size of the inter-module gap using at least one bumper between the modules and proximate the fluid ejection faces of the modules.

As indicated by block 504, a wiper is moved along the first ejection face of a first fluid ejection head on a first fluid ejection module. As indicated by block 508, wiper is further moved from the first module across a lower face of the first module adjacent the first ejection face towards a second module. As indicated by block 512, wiper is then moved across at least one bridging face of at least one bumper and across an inter-module gap onto the second module. During such movement, the wiper contacts the at least one bridging surface prior to contacting the second module. As indicated by block 516, the wiper is moved across a lower face of the second module. As indicated by block 520, the wiper is then moved along a second ejection face of a second fluid ejection head on the second module. Because the wiper contacts the least one bridging surface prior to contacting the second module, the least one bridging surface temporarily supports the wiper during the crossover, reducing or eliminating bounce of the wiper as it initiates contact with the second module.

FIG. 7 is a bottom view of portions of an example fluid ejection system 620. Fluid ejection system 620 is similar to fluid ejection system 420 except that fluid ejection system 620 comprises fluid ejection modules 624A and 624B (collectively referred to as modules 624). Modules 624 are similar to modules 424 described above except that body 325 each surround and support multiple parallel rows 627 of fluid ejection heads 28 along their lengths. Modules 624A and 624B further comprise bumpers 627A and 627B, respectively (collectively referred to as bumper 627). Bumpers 627 are similar to bumpers 427 described above except that bumpers 627 are specifically illustrated as having a width corresponding to a width of their respective module 624. In other words, bumper 627A extends across or spans across the ends of both of rows 627 of module 624A. Likewise, bumper 627B extends across or spans across the ends of both of rows 627 of modules 624B. in one implementation, wipe roller 250 also has a width so as to concurrently wipe both of throws 27 of fluid ejection heads 28 on one of module 624. In such an implementation, bumper 627 evenly supports wipe roller 250 across the width of module 624 as the wipe roller 250 crosses the inter-module gap G defined by the outermost answer tips of bumpers 627.

FIG. 8 is a bottom view illustrating portions of an example fluid ejection system 720. FIG. 8 illustrates a juncture of two example end-to-end fluid ejection modules 724A and 724B (collectively referred to as module 724B). Modules 724A, 724B each comprise a main body 725 supporting a bumper. The main body 725 of module 724A supports bumper 727A while main body 725 of module 724B supports bumper 727B. Each main body 725 comprises a module face 726 and rows 727-1, 727-2 of fluid ejection heads 728. Module faces 726 extend about fluid ejection faces 730 of fluid ejection heads 728. Module faces 726 of module 724 are substantially coplanar with one another.

Fluid ejection heads 728 are similar to fluid ejection heads 28 described above. Each of fluid ejection heads 728 comprises a fluid ejection die or multiple fluid ejection dives joined together as a unit or head. Each fluid ejection head 728 may comprise a plurality of parallel rows of fluid ejection orifices or nozzles through which fluid is ejected. For example, in one implementation, each row of nozzles may comprise a series of chambers supplied with fluid that is displaced through the orifices by fluid actuator. Examples of such a fluid actuator that may be utilized include, but are not limited to, thermal actuators, piezo-membrane based actuators, electrostatic membrane actuators, mechanical/impact driven membrane actuators, magnetostrictive drive actuators, electrochemical actuators, other such microdevices, or any combination thereof.

In the example illustrated, each main body 725 comprises a shroud 770 having openings 772 exposing a fluid ejection face 730 of respective fluid ejection head 728. In the example illustrated, fluid ejection faces 730 are parallel to module faces 726. In the example illustrated, fluid ejection heads 728 project through and beyond their respective openings 772. In other implementations, fluid ejection had 728 may be flush or may be slightly recessed within their respective opening 772. Each shroud 770 comprises a panel 780 forming the module face 726 and having the openings through which the fluid ejection heads 728 are exposed, an end wall 782 and a rim 784 outwardly projecting from the end wall 728.

In the example illustrated, bumpers 727 are formed as part of the shroud, formed below (above in FIG. 8) their respective rim 784 outwardly extending from end wall 782 away from panel 780. Each of bumpers 727 fills in the gap formed by the projecting rim 784 and provide a bridging surface 733 such that the inter-module gap between panels 780 is smaller.

As further shown by FIG. 8, the rows 727-1, 727-2 of fluid ejection head 728 of each of modules 724 are staggered relative to one another. In the example illustrated, the ends of modules 724 are each oppositely stepped, facilitating the overlap of row 727-1 of module 724A with respect to row 727-2 of module 724B. This overlap facilitates gapless printing or fluid ejection.

In the example illustrated, each of bumpers 727 continuously extends along the entire width of the respective module 724, across entire width of a respective main body 725. The reverse stepping of module 724 further results in row 727-1 of module 724A extending beyond a first portion of bumper 727A and a second portion of bumper 727A projecting beyond an end of row 727-2 of module 724B. Similarly, the reverse stepping of module 724 results in row 727-2 of module 724B extending beyond a first portion of bumpers 727B and a second portion of bumper 727B projecting beyond an end of row 727-1 of module 724A.

As with bumpers 427 described above, bumpers 727 reduce the size of any inter-module gap G. In one implementation, the opposing bumpers 727 along panel 780 are spaced by gap within the mesoscale range. In one implementation, the opposing bumpers are spaced by a distance no greater than 1.3 mm. In another implementation, the inter-module gap G is no greater than 7% of a diameter or radius of curvature of the profile 152, whether it be that of wipe roller 250 or convex wiper 150 (shown and described above).

Each of bumpers 727 has a bridging surface 733 facing same direction of fluid ejection faces 730. In the example illustrated, bridging surface 733 extends in a plane parallel to a plane containing module faces 726 of modules 724. In one implementation bridging surface 733 is coplanar with module faces 726, wherein the bridging surface 733 is flush with module faces 726. In another implementation, bridging surface 733 may be slightly recessed with respect to module faces 726, wherein wipe roller 250 (shown and described above), when moving from module 724A to module 724B contacts bridging surface 733 prior to contacting module 724B. In one implementation, bridging surfaces 733 are recessed from module faces 726 by no greater than 0.25 mm.

In one implementation, each of bumpers 727 is connected to end wall 782 of shroud 770. In one implementation, each of bumpers 727 is formed from a polymer or rubber material while shroud 770 is formed from a metal. In such an implementation, each of bumpers 727 may be attached through adhesive, heat staking or other methods. In other implementations, each of bumpers 727 may be formed from a metal material which is spot welded or otherwise fixed to end wall 782 of shroud 770.

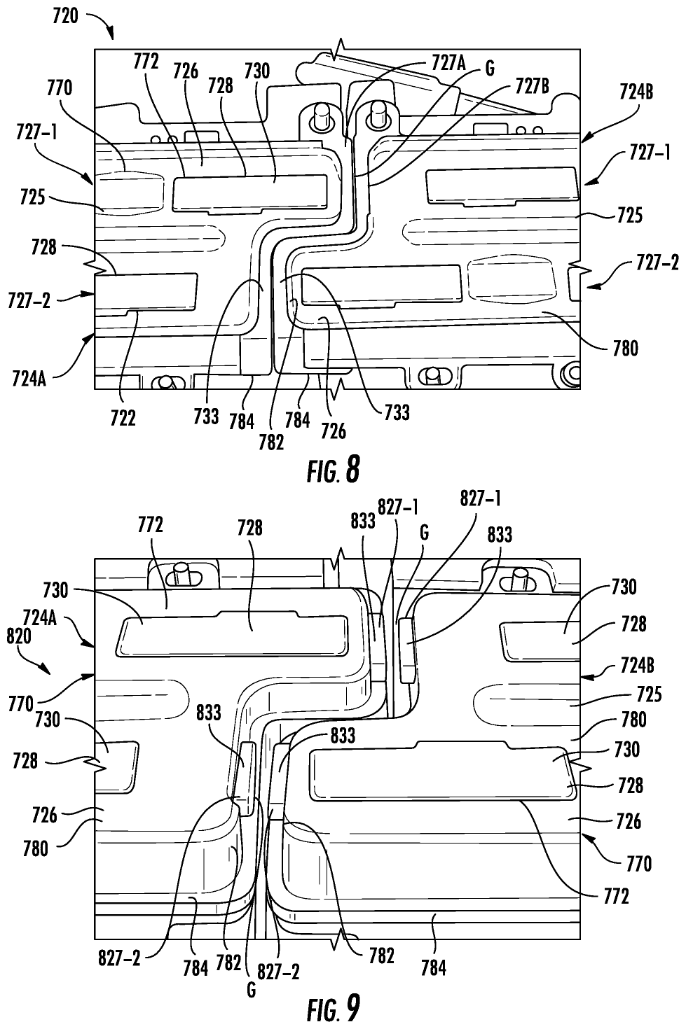

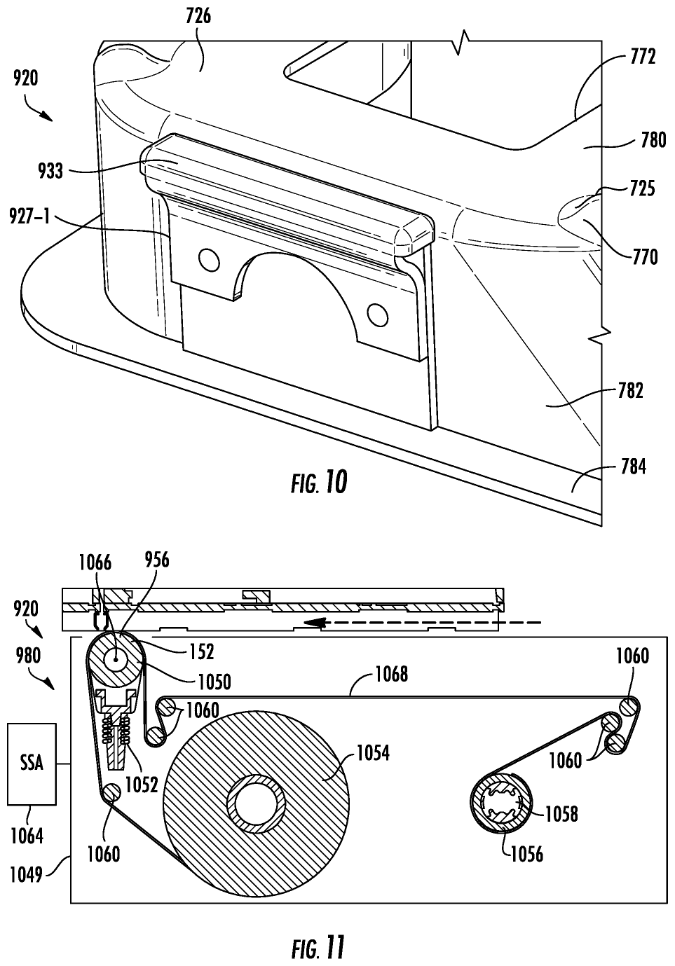

FIG. 9 schematically illustrates portions of an example fluid ejection system 820. Fluid ejection system 820 is similar to fluid ejection system 720 described above except that each of modules 724 comprises spaced bumpers 827-1 and 827-2 (collectively referred to as bumpers 827) in place of a single bumper 727. Each of bumpers 827 comprises a polymer or rubber material secured to end wall 782 of shroud 770. Each of bumpers 827 may be attached through adhesive, heat staking or other methods. In other implementations, each of bumper 827 may be formed from a metal material which is spot welded or otherwise fixed to and wall 782 of shroud 770. Each of bumpers 827 has a width greater than or equal to a width of fluid ejection face 730 of the fluid ejection heads 728.

As with bumpers 727 described above, bumpers 827 reduce the size of any inter-module gap G. In one implementation, opposing bridging surfaces 733 of bumpers 727 are spaced by a distance within the mesoscale range. In one implementation, the opposing bridging surfaces 733 of bumper 727 are spaced by a distance no greater than 1.3 mm. In another implementation, the inter-module gap G is no greater than 7% of a diameter or radius of curvature of the profile 152, whether it be that of wipe roller 250 or convex wiper 150 (shown and described above).

Bridging surfaces 833 face in a same direction as fluid ejection faces 730. In the example illustrated, each bridging surface 733 extends in a plane parallel to a plane containing module faces 726 of modules 724. In one implementation bridging surface 833 is coplanar with module faces 726, wherein the bridging surface 833 is flush with module faces 726. In another implementation, bridging surface 833 may be slightly recessed with respect to module faces 726, wherein wipe roller 250 (shown and described above), when moving from module 724A to module 724B contacts bridging surface 833 prior to contacting module 724B. In one implementation, bridging surfaces 833 are recessed from module faces 726 by no greater than 0.25 mm.

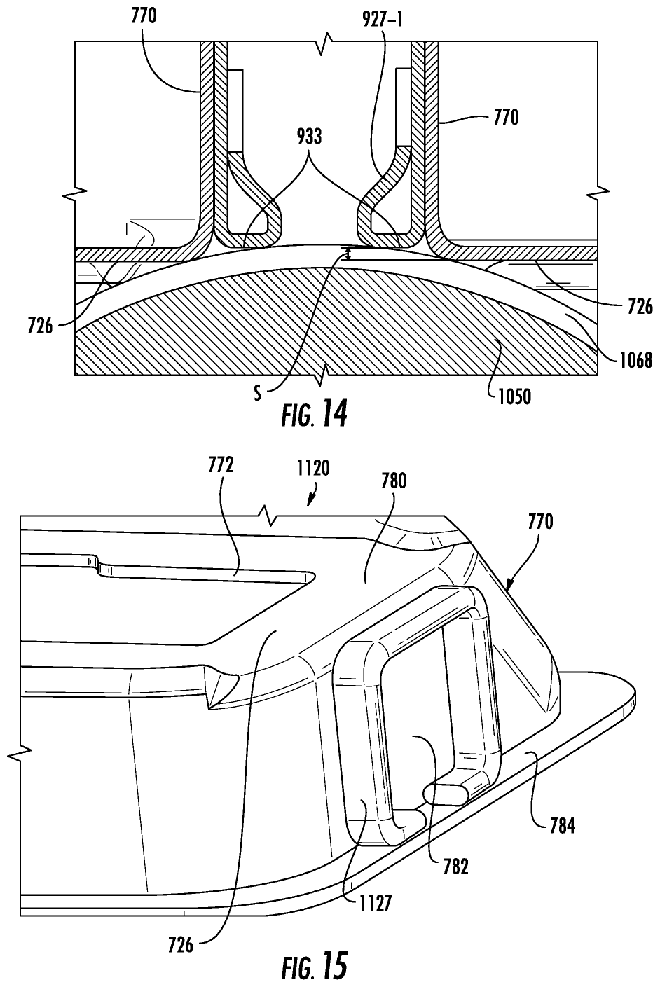

FIGS. 10-13 illustrate portions of an example fluid ejection system 920. FIG. 10 is a perspective view illustrating portions of an example bumper 927-1 mounted to shroud 770 (described above) for use as part of a fluid ejection module 924A and fluid ejection module 924B shown in FIG. 12. Bumper 927-1 comprises a stamped sheet metal strip bent or otherwise forming a bridging surface 933 which is flush with the adjacent portions of panel 780 of main body 725. In one implementation, bumper 927-1 is attached to the metal of shroud 770 by spot welding. In yet other implementations, bumper 927-1 may be secured to end wall 782 by adhesives or fasteners such as rivets. In some implementations, bumper 927-1 may be integrally formed as part of a single unitary body with shroud 770. For example, bumper 927-1 may comprise an extension of panel 780. Bumpers 927-2 (shown in FIGS. 12 and 13) may be formed and secured in a similar fashion.

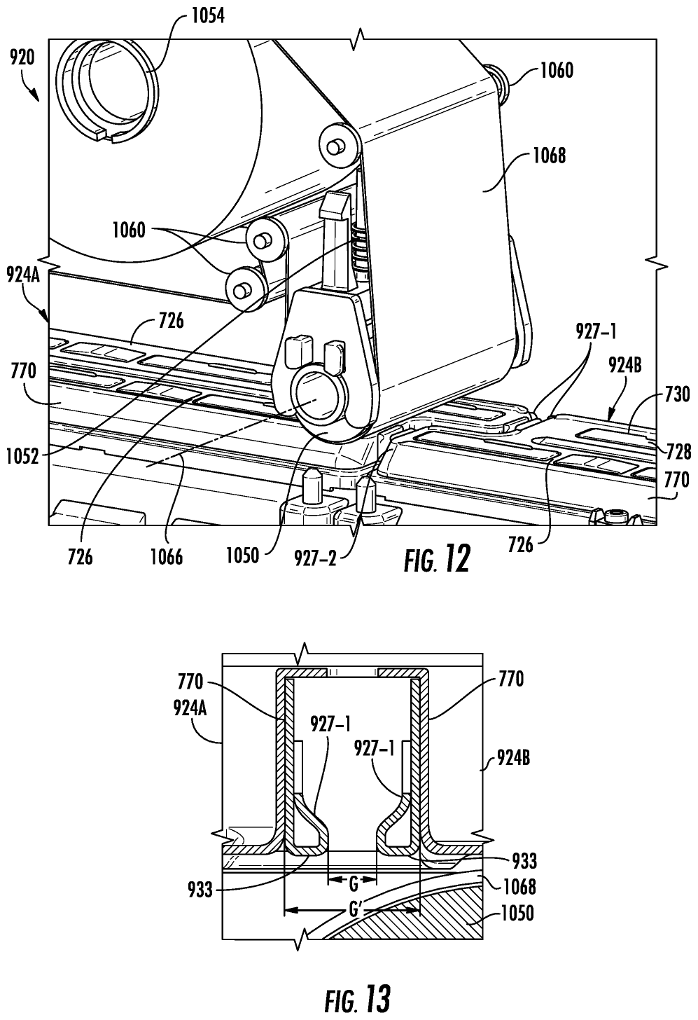

FIGS. 11 and 12 illustrate an example wiping subsystem 980 of fluid ejection system 920. Wiping subsystem 980 wipes fluid ejection faces 730 of fluid ejection heads 728. Wiping subsystem 980 comprises support 1049, wipe roller 1050, bias spring 1052, wiping web supply 1054, waste wiping web take-up roller 1056, take-up drive 1058, tension rollers 1060 and service station actuator 1064. Support 1049 comprise a housing, bracket or other structure that supports remaining components of subsystem 980 such that the components may be moved as a unit relative to and across modules 924 by service station actuator 1064. Wipe roller 1050 is similar wipe roller 250 described above. In the example illustrated, wipe roller 250 rotates about a rotational axis 1066. Wipe roller 1050 rotates as a web 1068 of wiping material, that is an absorbent wipe material, is supplied about roller 1050, between the apex 956 of roller 1050 and module surfaces 726 of modules 924.

Bias spring 1052 resiliently biases roller 150 towards module faces 726 and towards fluid ejection faces 730. Wiping web supply 1054 comprises a roll of wiping material. Waste wiping web take-up roller 1056 takes up portions of web 1068 that have been used, that may contain absorbed fluid taken from the fluid ejection faces 930 of fluid ejection heads 728. Take-up drive 1058 comprises an electrically powered motor that rotates roller 1056 to controllably move web 1068 across apex 956 of roller 1050. Tension rollers 1060 maintain web 1068 in tension. Service station actuator 1064 (schematically illustrated) comprises a drive for moving support 1049 (and the remaining components of wiping subsystem 980) across modules 924A, 924B.

As shown by FIG. 12, fluid ejection modules 924A, 924B (collectively referred to as fluid ejection modules 924) are each similar to fluid ejection modules 724 except that fluid ejection modules 924 each comprise bumpers 927-1 and 297-2. As with bumpers 827, bumpers 927-1 extend opposite to one another and bumpers 927-2 extend opposite to one another, bridging between the modules 924 to define the smaller inter-module gaps between the ends of such opposing bumpers 927.

FIG. 13 illustrates two of the opposing bumpers, bumpers 927-1 of modules 924 in more detail. As shown by FIG. 13, each of modules 927-1 form the bridging surface 933 which reduces the inter-module gap from G′ to G. In one implementation, the inter-module gap G is reduced by at least 40%. In one implementation, the inter-module gap G is reduced to a gap of no greater than 1.3 mm. In another implementation, the inter-module gap G is no greater than 7% of a diameter or radius of curvature of the profile 152 of wipe roller 1050. The reduced inter-module gap reduces bouncing of wipe roller 1050 and the backed wiping web as wipe roller 1050 crosses between consecutive modules 924.

As shown by FIG. 14, in other implementations, bumpers 927-1 (as well as bumpers 927-2) may be slightly recessed from module face 726, wherein wipe roller 1050 and web 1068, during movement from module 924A to module 924B (and vice versa) bear upon at least one of bridging services 933 prior to reaching the opposing edge of the destination module. In one implementation, bridging services 933 are spaced from module faces 726 by a spacing S of no greater than 0.25 mm. In yet other implementations, the spacing may vary depending upon the diameter of wipe roller 1050.

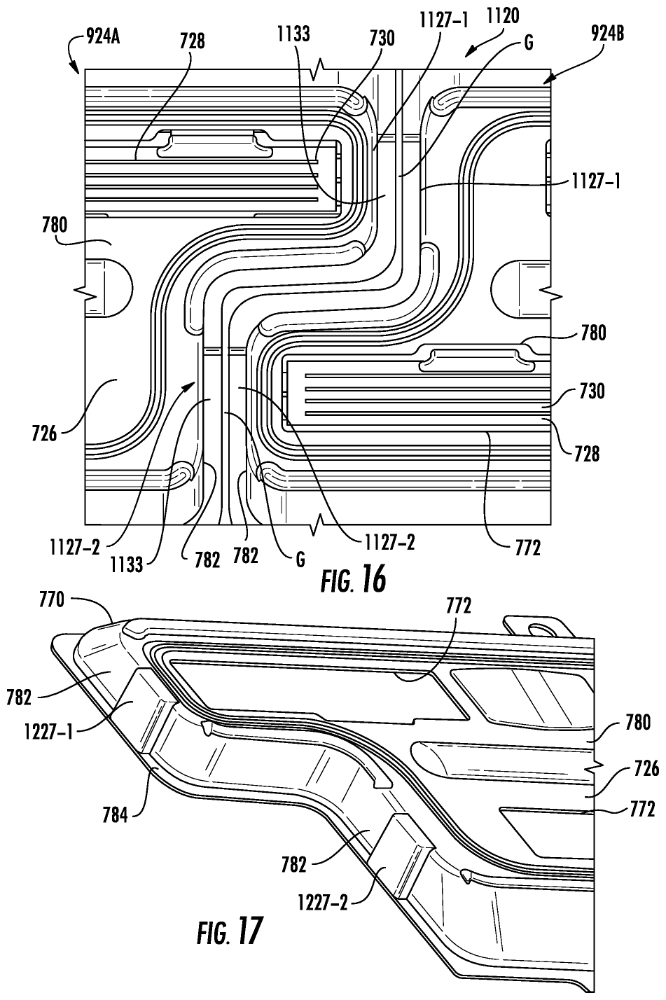

FIGS. 15 and 16 illustrate portions of an example fluid ejection system 1120. System 1120 is similar to system 920 described above except that each of modules 924 comprises bumpers 1127-1, 1127-2 (collectively referred to as bumpers 1127) in place of bumpers 927-1, 927-2. Those remaining components of system 1120 which correspond to components of system are numbered similarly and/or are shown in FIGS. 11 and 12.

Bumpers 1027 are similar to bumpers 927 except that bumpers 1027 comprise looped bumpers, a loop of material or an open loop of material joined to end wall 782 of shroud 770. In one implementation, bumpers 1127 comprise a loop or partial loop of wire spot welded at multiple points to end wall 782 of shroud 770. In another implementation, bumpers 1027 may be joined to end wall 782 through adhesive, fasteners or the like. In yet other implementations, bumpers 1127 may be formed from a polymer which is joined to end wall 782.

As with the above described bumpers, bumpers 1127 reduce the inter-module gap from G′ to G. In one implementation, the reduced inter-module gap G is no greater than 1.3 mm. In another implementation, the inter-module gap G is no greater than 7% of a diameter or radius of curvature of the profile 152 of wipe roller 1050 (shown in FIGS. 11 and 12). The reduced inter-module gap reduces bouncing of wipe roller 1050 and the backed wiping web 1068 as wipe roller 1050 crosses between consecutive modules 924.

FIG. 17 illustrates another implementation of example bumpers that may be provided on a shroud of a fluid ejection module. FIG. 17 illustrates shroud 770 supporting bumpers 1227-1, 1227-2 (collectively referred to as bumpers 1227). Bumpers 1227 comprise blocks of material, such as blocks a metal or polymer material, secured to end wall 782 of shroud 770. Such blocks may be secured in wall 782 through welding, adhesives, fasteners or interlocking mechanisms.

Such blocks forming bumpers 1227 have a thickness so as to reduce the inter-module or gap between consecutive modules. As with the above described bumpers, bumpers 1227 reduce the inter-module gap from G′ to G. In one implementation, the inter-module gap is no greater than 1.3 mm. In another implementation, the inter-module gap G is no greater than 7% of a diameter or radius of curvature of the profile 152 of wipe roller 1050 (shown in FIGS. 11 and 12). The reduced inter-module gap reduces bouncing of wipe roller 1050 and the backed wiping web 1068 as wipe roller 1050 crosses between consecutive modules 924.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. 1 A fluid ejection system comprising:
a first fluid ejection module comprising a first module face and a first row of first ejection heads having first ejection faces along the first module face, the first module face having a first end;
a second fluid ejection module comprising a second module face and a second row of second ejection heads having second ejection faces along the second module face, the second module having a second end opposite the first end; and
a wiper to be moved from the first fluid ejection module to the second fluid ejection module, wherein the first module face is spaced from the second module face by an inter-module mesoscale gap.

2. The fluid ejection system of claim 1, wherein the wiper comprises a rounded wiper having a diameter, wherein the intermodule mesoscale gap is less or equal to 7% of the diameter.

3. The fluid ejection system of claim 1, wherein the first fluid ejection module comprises:
a body extending between the first ejection heads and connecting the first ejection heads as a single unit, the body having a lower face adjacent the first fluid ejection faces and extending in a first plane; and
a bumper outwardly extending from an end of the body, the bumper having an outer tip forming the first end of the module, the bumper having a bridging face extending in a second plane parallel wiper, when moving from the first module to the second module, contacts the bridging face prior to contacting the second module.

4. The fluid ejection system of claim 3, wherein the bumper is joined to the body.

5. The fluid ejection system of claim 3, wherein the bumper is integrally formed as a single unitary body with the body.

6. The fluid ejection system of claim 3, wherein the second fluid ejection module further comprises:
a second body extending between the second ejection heads and connecting the second ejection heads as a second single unit; and
a second bumper outwardly extending from an end of the second body opposite, the second bumper having an outer tip forming the second end of the second module.

7. The fluid ejection system of claim 6, wherein the second fluid ejection module comprises a third row of third fluid ejection heads projecting beyond the second row of second fluid ejection heads and overlapping the first row of first fluid ejection heads of the first fluid ejection module.

8. The fluid ejection system of claim 1, wherein the body comprises a shroud having openings through which the first ejection heads project.

9. The fluid ejection system of claim 1, wherein the first module further comprises:
a third row of third ejection heads parallel to the first row;
a body extending between and joining the first row of first ejection heads and the third row of third ejection heads as a single unit; and
a bumper outwardly extending from an end of the body, the bumper having an outer tip forming the first end of the module, the bumper having a bridging face continuously extending along the end of the body opposite to an end of the first row and an end of the second row second such that the wiper, when moving from the first module to the second module, contacts the bridging face prior to contacting the second module.

10. The fluid ejection system of claim 9, wherein the first row is staggered relative to the third row, wherein the bridging face has a first portion opposite the end of the first row and a second portion opposite the end of the second row, the second row extending beyond the first portion of the bumper.

11. The fluid ejection system of claim 1, wherein the first module further comprises:
a third row of third ejection heads parallel to the first row;
a body extending between and joining the first row of first ejection heads and the third row of third ejection heads as a single unit;
a first bumper outwardly extending from an end of the body opposite the first row of first ejection heads; and
a second bumper spaced from the first bumper and outwardly extending from the end of the body opposite the third row each having a bridging face such that the wiper, when moving from the first module to the second module, contacts the bridging face prior to contacting the second module.

12. The fluid ejection system of claim 11, wherein the first row is staggered relative to the third row and wherein the third row of third ejection heads extends beyond the first bumper.

13. A method for wiping fluid ejection heads of consecutive fluid ejection modules, the method comprising:
moving a wiper along a first ejection face of a first fluid ejection head on a first module; and
moving the wiper from the first module across a lower face of the first module adjacent the first ejection face towards a second module;
moving the wiper across at least one bridging surface of at least one bumper and across an inter-module gap onto the second module, wherein the wiping roller contacts the at least one bridging surface prior to contacting the second module;
moving the wiper across a lower face of the second module; and
moving the wiper along a second ejection face of a second fluid ejection head on the second module.

14. The method of claim 13, wherein the lower face of the first module and the lower face of the second module are separated by a gap and wherein the at least one bumper comprises a first bumper extending from the first module and a second bumper extending from the second module towards the first bumper, the first bumper and the second bumper at least partially bridging the gap.

15. A shroud for fluid ejection heads of a fluid ejection module, the shroud comprising:
a panel extending in a plane and having openings through which the fluid ejection heads project;
an end wall projecting from the panel;
a rim extending outwardly from the end wall away from the panel; and
a bumper extending outwardly from the end wall away from the panel, the bumper having a bridging surface spaced from the
